(19) United States
(12) Patent Application Publication
(10) Pub. No.: US 2010/0271413 A1
(43) Pub. Date: Oct. 28, 2010

(54) IMAGE FORMING APPARATUS

(75) Inventors: Takashi KADO, Shizuoka-ken (JP); Minoru YOSHIDA, Tokyo (JP); Takeshi WATANABE, Kanagawa-ken (JP); Yoshiaki KANEKO, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/765,499

(22) Filed: Apr. 22, 2010

Related U.S. Application Data
(60) Provisional application No. 61/173,090, filed on Apr. 27, 2009.
(60) Provisional application No. 61/173,095, filed on Apr. 27, 2009.

(51) Int. Cl. B41J 29/38

(52) U.S. Cl. 347/14

(57) ABSTRACT

An image forming apparatus includes: an ink-jet head configured to eject ink to form an image on a sheet; and a controller configured to control an amount of the ink ejected from the ink-jet head and reduce an ejection amount of the ink ejected to a damaged sheet to be smaller than an ejection amount of the ink ejected to an undamaged sheet.

### CROSS-REFERENCE TO RELATED APPLICATION

This application is based upon and claims the benefit of priority from: U.S. provisional application 61/173,090, filed on Apr. 27, 2009; and U.S. provisional application 61/173,095, filed on Apr. 27, 2009, the entire contents of each of which are incorporated herein by reference.

### FIELD

This specification relates to a technique for ejecting ink to form an image on a damaged sheet.

### BACKGROUND

In order to protect the earth environment, it is necessary to efficiently use paper resources. There is proposed ink that changes from a color developing state to an erased state when heat is applied thereto. If the erasable ink is used, a sheet can be repeatedly used. A technique for an image forming material that changes from the color developing state to the erased state is described in JP-A-2008-233806.

However, when formation and erasing of an image is repeated, it is likely that deterioration of a sheet worsens and the quality of images formed on the sheet falls.

### SUMMARY

This specification relates to an image forming apparatus including: an ink-jet head configured to eject ink to form an image on a sheet; and a controller configured to control an amount of the ink ejected from the ink-jet head and reduce an ejection amount of the ink ejected to a damaged sheet to be smaller than an ejection amount of the ink ejected to an undamaged sheet.

This specification relates to an image forming apparatus including: an ink-jet head configured to eject ink to form an image on a sheet; a sensor configured to detect damage level of a sheet; and a controller configured to specify a damaged area in the sheet on the basis of an output of the sensor and vary, when the damaged area and a printing area overlap each other, timing for driving the ink-jet head to shift the printing area in a conveying direction with respect to the damaged area.

This specification relates to an image forming apparatus including: an ink-jet head configured to eject ink to form an image on a sheet; a sensor configured to detect damage level of a sheet; a shift mechanism for moving the sheet in a direction orthogonal to a sheet conveying direction; and a controller configured to specify a damaged area in the sheet on the basis of an output of the sensor and actuate, when the damaged area and a printing area overlap each other, the shift mechanism to shift the printing area in the direction orthogonal to the sheet conveying direction with respect to the damaged area.

### DESCRIPTION OF THE DRAWINGS

FIG. 1 is a sectional view of an image forming apparatus according to a first embodiment;

FIG. 2 is a schematic diagram of the image forming apparatus according to the first embodiment;

FIG. 3A is a graph of a relation between a position of a sheet in a conveying direction and damage level;

FIG. 3B is a graph of a relation between a position in the width direction of the sheet and the damage level;

FIG. 4 is a flowchart for explaining the operation of the image forming apparatus according to the first embodiment;

FIG. 5A is a graph of a relation between the damage level of the sheet and an upper limit value of the damage level;

FIG. 5B is a graph of a relation between a difference between a peak value and the upper limit value of the damage level and a rate of decrease in an ink ejection amount;

FIG. 6 is a flowchart for explaining the operation of an image forming apparatus according to a second embodiment;

FIG. 7 is a diagram of a state in which a printing area is shifted in a conveying direction of a sheet with respect to a reference position in the second embodiment;

FIG. 8 is a flowchart for explaining the operation of an image forming apparatus according to a third embodiment;

FIG. 9 is a schematic diagram of a shift mechanism in the third embodiment;

FIG. 10 is a diagram of a state in which a printing area is shifted in the width direction of a sheet with respect to a reference position;

FIG. 11 is a flowchart for explaining the operation of an image forming apparatus according to a fourth embodiment; and

FIG. 12 is a diagram of a positional relation between a printing area and a damaged area in the fourth embodiment.

### DETAILED DESCRIPTION

Embodiments are explained below with reference to the accompanying drawings.

### First Embodiment

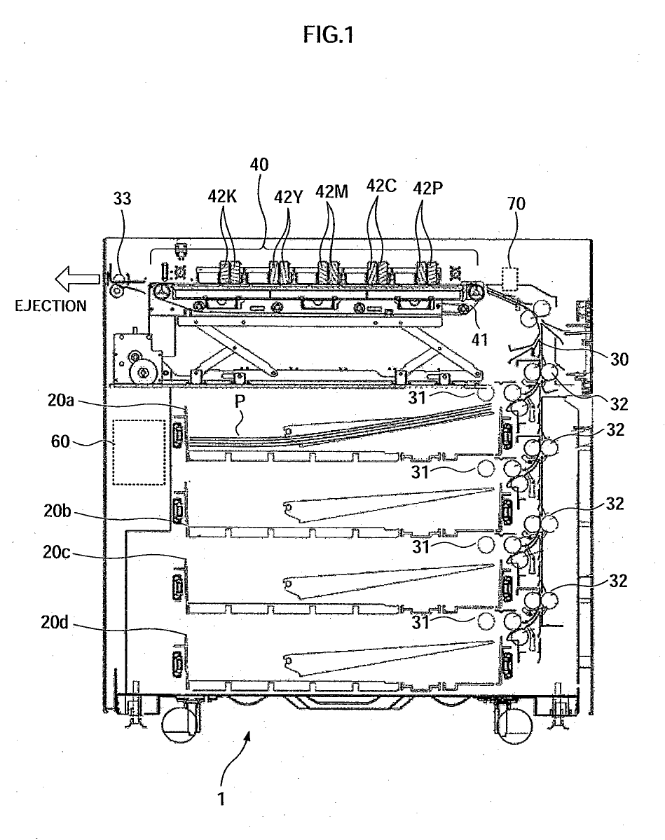

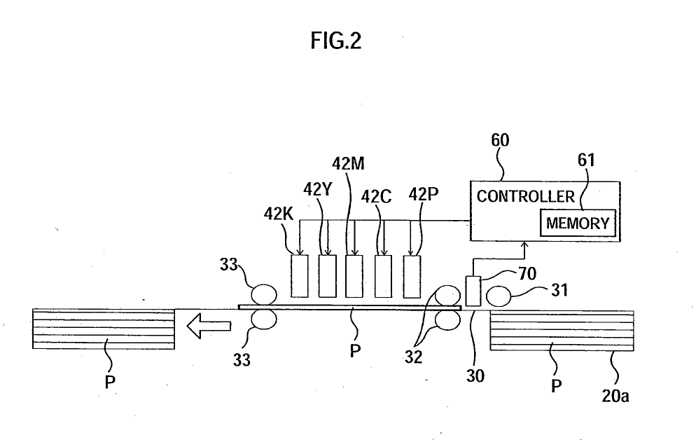

FIG. 1 is a longitudinal sectional view of the overall configuration of an image forming apparatus according to a first embodiment. FIG. 2 is a schematic diagram of the configuration of the image forming apparatus according to this embodiment.

A housing 10 houses components of an image forming apparatus 1. The image forming apparatus 1 includes four paper feeding cassettes 20a to 20d. Each of the paper feeding cassettes 20a to 20d stores plural sheets P.

The sheets P stored in the paper feeding cassettes 20a to 20d are separated one by one by pickup rollers 31 and led to a sheet conveying path 30. Plural conveying rollers 32 are arranged in the sheet conveying path 30. The sheet P from each of the paper feeding cassettes 20a to 20d moves on the paper conveying path 30 and reaches an image forming unit 40.

In the sheet conveying path 30, a damage detection sensor 70 is arranged on an upstream side of the image forming unit 40. Details of the damage detection sensor 70 are explained later.

In the image forming unit 40, the sheet P is conveyed by a belt 41. The image forming unit 40 performs image forming processing while conveying the sheet P. The belt 41 is arranged along a driving roller and plural driven rollers. The belt moves with rotation force of the driving roller. Appropriate tension is applied to the belt 41 by an action of a tension roller.

Plural ink-jet heads 42P, 42C, 42M, 42Y, and 42K configured to eject inks of colors different from one another are arranged in positions on the belt 41 opposed to an area where the sheet P is conveyed. The plural ink-jet heads 42P to 42K have the same structure.

Each of the ink-jet heads 42P to 42K includes a nozzle configured to eject ink and an ejecting mechanism for generating force for causing the nozzle to eject the ink. Each of the ink-jet heads 42P to 42K is arranged along the width direction of the sheet P (a direction orthogonal to the paper surface of FIG. 1) and arranged in an area corresponding to the width of the sheet P.

In this embodiment, it is unnecessary to move the ink-jet heads 42P to 42K in the width direction of the sheet P. It is possible to form an image over the entire surface of the sheet P simply by ejecting the ink. On the other hand, a mechanism for moving an ink-jet head in the width direction of a sheet can be used.

As the ejecting mechanism for the ink, for example, there is a mechanism for deforming a piezoelectric element to cause the ink-jet head to eject the ink (so-called piezoelectric system). There is also a mechanism for expanding and compressing air bubbles generated by heating the ink to thereby cause the ink-jet head to eject the ink (so-called thermal system).

The ink ejected from each of the ink-jet heads 42P to 42K is ink, a color of which can be erased by applying heat to the ink. Since components of the erasable ink are publicly known, detailed explanation of the components is omitted.

When an image is formed on a sheet by using the erasable ink, the image formed on the sheet can be erased by applying heat to the sheet. The sheet from which the image is erased can be stored in the paper feeding cassettes 20a to 20d and reused.

The ink-jet heads 42P are arranged on the most upstream side of the sheet conveying path 30 in the image forming unit 40 and eject pre-treatment liquid to the sheet P. The ink-jet heads 42C are arranged further on a downstream side of the sheet conveying path 30 than the ink-jet heads 42P and eject cyan ink to the sheet P.

The ink-jet heads 42M are arranged further on the downstream side of the sheet conveying path 30 than the ink-jet heads 42C and eject magenta ink to the sheet P. The ink-jet heads 42Y are arranged further on the downstream side of the sheet conveying path 30 than the ink-jet heads 42M and eject yellow ink to the sheet P. The ink-jet heads 42K are arranged further on the downstream side of the sheet conveying path 30 than the ink-jet heads 42Y and eject black ink to the sheet P.

The ink-jet heads 42P to 42K eject the inks on the basis of image data input to the image forming apparatus 1. A color image is formed on the sheet P passed through the ink-jet heads 42P to 42K. A monochrome image can also be formed on the sheet P.

The sheet P having the image formed thereon is discharged to a paper discharge tray (not shown), which is arranged on the outside of the image forming apparatus 1, by a discharge roller 33.

A controller 60 controls the operation of the image forming apparatus 1. In particular, in this embodiment, the controller 60 controls an amount of the ink ejected from each of the ink-jet heads 42P to 42K.

The controller 60 has a role of performing various kinds of processing in the image forming apparatus 1. The controller 60 also has a role of realizing various functions by executing computer programs. A memory 61 incorporated in the controller 60 can include, for example, a RAM (Random Access Memory), a ROM (Read Only Memory), a DRAM (Dynamic Random Access Memory), an SRAM (Static Random Access Memory), or a VRAM (Video RAM). The memory 61 has a role of storing various kinds of information and computer programs used in the image forming apparatus 1. The memory 61 can also be provided on the outside of the controller 60.

In this embodiment, the controller 60 changes, according to damage level of the sheet P, amounts of the inks ejected from the ink-jet heads 42P to 42K. If the erasable ink is used as in this embodiment, it is possible to repeatedly use the sheet P while erasing images. However, if the sheet P is repeatedly used, damage is accumulated in the sheet P.

As parameters for determining the damage level, for example, there are surface roughness and thickness of the sheet P. The controller 60 can determine that the sheet P is more deteriorated as fluctuation in the surface roughness of the sheet P is larger. The fluctuation in the surface roughness means that, when the surface roughness is measured in plural positions on the sheet P, the surface roughness is different depending on the positions. The surface roughness includes center line average roughness (Ra), maximum height (Rmax), and ten point average height (Rz).

The controller 60 can determine that the sheet P is more deteriorated as the fluctuation in the thickness of the sheet P is larger. The fluctuation in the thickness means that, when the thickness of the sheet P is measured in plural positions on the sheet P, the thickness is different depending on the positions.

The damage detection sensor 70 is used to detect damage level of the sheet P led to the image forming unit 40. An output of the damage detection sensor 70 is input to the controller 60.

When the thickness of the sheet P is detected, a contact sensor or an optical sensor can be used as the damage detection sensor 70. Concerning the contact sensor and the optical sensor, various configurations are proposed. Publicly-known configurations can be used as appropriate. When the surface roughness of the sheet P is detected, an optical sensor can be used as the damage detection sensor 70. Concerning the optical sensor, various configurations are proposed. A publicly-known configuration can be used as appropriate.

The damage detection sensor 70 only has to be arranged in a conveying path for conveyance of the sheet P from each of the paper feeding cassettes 20a to 20d to the image forming unit 40. Specifically, it is sufficient that a damage state of the sheet P can be detected by the damage detection sensor 70 before the sheet P reaches the image forming unit 40.

The controller 60 acquires the distribution of damage level on the sheet P on the basis of an output of the damage detection sensor 70. The damage level indicates a degree of fluctuation in the surface roughness of the sheet P and a degree of fluctuation in the thickness of the sheet P.

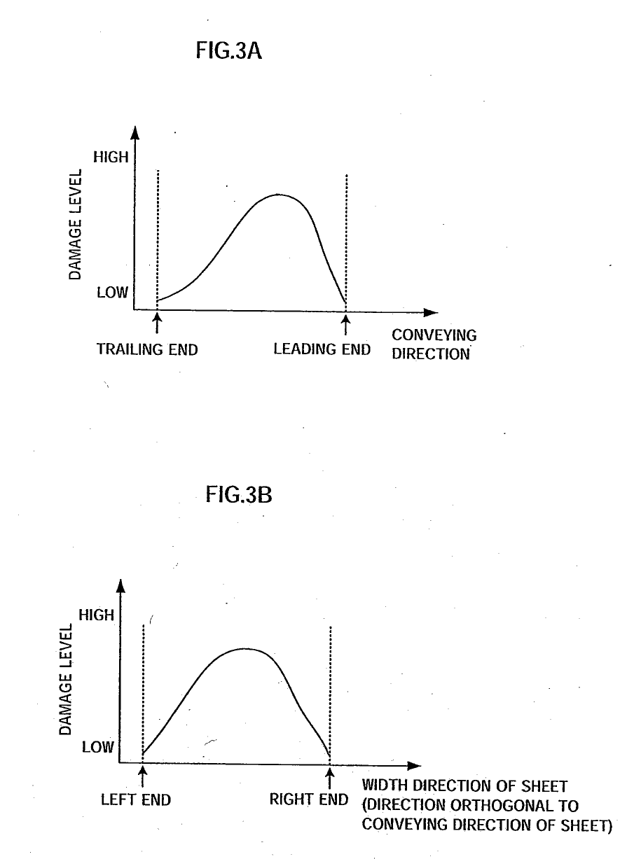

The damage detection sensor 70 detects a damage state over the entire surface of the sheet P. The controller 60 can acquire the distribution of damage level over the entire surface of the sheet P. For example, the controller 60 can acquire the distribution of damage level shown in FIGS. 3A and 3B.

FIG. 3A is a graph of a relation (an example) between a position in the conveying direction and damage level. FIG. 3B is a graph of a relation (an example) between a position in the width direction (a direction orthogonal to the conveying direction) and the damage level, in the sheet P. It is possible to acquire the distribution (three-dimensional distribution) of damage level over the entire surface of the sheet P by combining the distributions of damage level in FIGS. 3A and 3B.

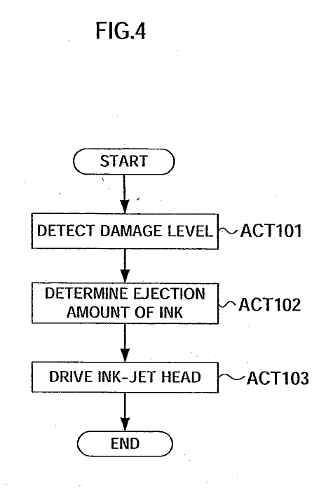

Operation in a part of the controller 60 is explained according to a flowchart shown in FIG. 4.

The controller 60 detects a damage state of the sheet P on the basis of an output of the damage detection sensor 70 (ACT 101). Specifically, the controller 60 acquires the distribution of damage level of the sheet P.

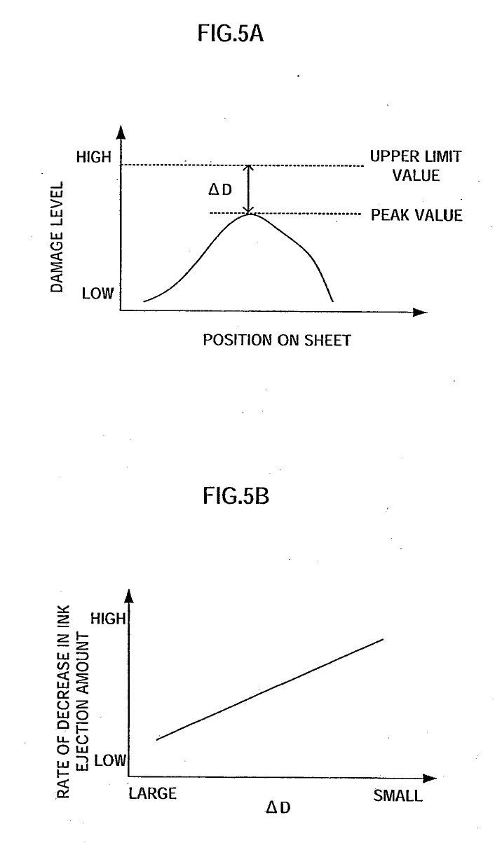

The controller 60 compares a peak value of the damage level and an upper limit value of the damage level. The upper limit value of the damage level is damage level at which the quality of an image formed on the sheet P can be maintained. The upper limit value of the damage level can be set in advance. The upper limit value of the damage level can be stored in the memory 61 of the controller 60. In FIG. 5A, a relation (an example) between the damage level of the sheet P and the upper limit value is shown. A difference between the peak value and the upper limit value of the damage level is represented as ΔD.

The controller 60 determines an ejection amount of ink using a map indicating a relation between the difference between the peak value and the upper limit value and a rate of decrease in the ejection amount of the ink (ACT 102). The memory 61 has the map stored therein.

In FIG. 5B, a relation (an example) between the difference (ΔD) between the peak value and the upper limit value and the rate of decrease in the ejection amount of the ink is shown. The rate of decrease in the ejection amount of the ink indicates a rate of decrease with respect to an amount of the ink ejected to the sheet P when an image is formed for the first time by using the ink.

In FIG. 5B, the rate of decrease in the ejection amount of the ink is continuously changed with respect to AD. However, the rate of decrease can also be changed stepwise. In FIG. 5B, the rate of decrease in the ink ejection amount is shown. Specifying the rate of decrease in the ink ejection amount is specifying a rate of the ink ejection amount after the decrease.

If the ink is ejected to the sheet P, the sheet P is damaged and the peak value of the damage level approaches the upper limit value. Therefore, it is desirable to further reduce the ejection amount of the ink as the difference (ΔD) between the peak value and the upper limit value decreases. It is possible to delay the worsening of damage to the sheet P by reducing the ejection amount of the ink.

In this embodiment, the ejection amount of the ink is determined by using the map (see FIG. 5B). However, it is also possible to calculate the ejection amount of the ink according to arithmetic processing using the peak value and the upper limit value of the damage level.

The controller 60 drives each of the ink-jet heads 42P to 42K on the basis of the ejection amount of the ink determined in ACT 102 (ACT 103). The controller 60 can adjust the ejection amount of the ink by controlling the operation of the ejecting mechanism in each of the ink-jet heads 42P to 42K.

In this embodiment, a rate of a reduction of the ink is set the same in the ink-jet heads 42P to 42K.

An image is formed on the sheet P by the processing in ACT 103. The sheet P having the image formed thereon is conveyed to the paper discharge tray by the discharge roller 33. When the image formed on the sheet P is unnecessary, the image can be erased by applying heat to the sheet P. The sheet P can be reused.

In this embodiment, it is possible to suppress the worsening of deterioration of the sheet P due to the ejection of the ink by reducing the ejection amount of the ink when the sheet P is damaged. In particular, when images are repeatedly formed on the sheet P by using the erasable ink, it is possible to delay deterioration of the sheet P and extend the life of the sheet P.

In this embodiment, it is possible to correct, on the basis of an environment of use of the sheet P, the ejection amount of the ink determined in ACT 102. As the environment of use, for example, there is humidity. If the humidity rises, even if the ejection amount of the ink is increased, influence on the deterioration of the sheet P is small. In other words, it is possible to change an amount of a reduction of the ink further in a decreasing direction as the humidity is lower.

For example, it is possible to store a map of reference humidity (a map corresponding to FIG. 5B) in the memory 61 of the controller 60 and correct a rate of decrease in the ejection amount of the ink obtained from the map according to a difference between the reference humidity and the present humidity. When the present humidity is lower than the reference humidity, it is possible to correct the ejection amount of the ink further in a decreasing direction as the difference between the reference humidity and the present humidity is larger. When the present humidity is higher than the reference humidity, it is possible to correct the ejection amount of the ink further in an increasing direction as the difference between the reference humidity and the present humidity is larger.

In this embodiment, a damage state is detected over the entire surface of the sheet P. However, a damage state can also be detected in an area in a part of the sheet P.

If a damage state is detected over the entire surface of the sheet P, an area where damage worsens (a damaged area) on the sheet P can be specified. For example, an area where damage level exceeds a reference value can be specified as the damaged area. When print processing is applied to the area where damage worsens, the ink can be ejected by an amount smaller than an ejection amount of the ink to other areas. In other words, it is also possible to vary the ejection amount of the ink according to a position on the sheet P.

The controller 60 can determine whether the damaged area and a printing area overlap each other and reduce the ejection amount of the ink only if the printing area overlaps the damaged area.

It is possible to determine whether the printing area overlaps the damaged area by comparing a position of the damaged area in the sheet P and a position of the printing area in the sheet P. It is possible to determine, according to a ratio of an area of the printing area overlapping the damaged area, whether the ejection amount of the ink should be reduced. Specifically, the ejection amount of the ink can be reduced if the ratio of the area of the printing area overlapping the damaged area is higher than a predetermined value.

On the other hand, if the printing area does not overlap the damaged area, it is possible to form an image without reducing the ejection amount of the ink.

In this embodiment, the damage detection sensor 70 is used. However, the damage detection sensor 70 can be omitted. If the damaged sheet P is stored in advance in any one of the paper feeding cassettes 20a to 20d, damage to the sheet P does not have to be detected. It is sufficient to determine in advance a paper feeding cassette in which the damaged sheet P is stored and reduce the ejection amount of the ink ejected to the sheet P conveyed to the image forming unit 40 from the paper feeding cassette.

### Second Embodiment

An image forming apparatus according to a second embodiment is explained below. Members having functions same as those of the members explained in the first embodiment are denoted by the same reference numerals and signs and detailed explanation of the members is omitted. Differences from the first embodiment are mainly explained below.

In the first embodiment, deterioration of a sheet is prevented from worsening by reducing the ejection amount of the ink. However, in the second embodiment, deterioration of a sheet is prevented from worsening by shifting a position where an image is formed.

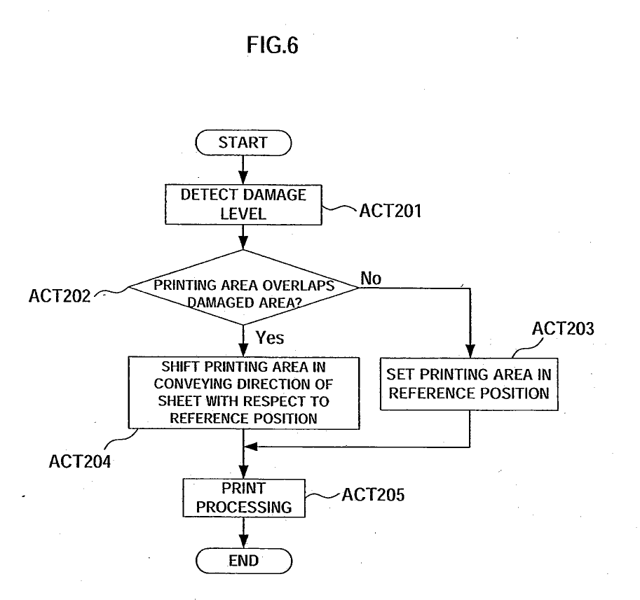

The operation (image forming processing) of the image forming apparatus 1 according to this embodiment is explained with reference to FIG. 6. Processing shown in FIG. 6 is performed by the controller 60.

The controller 60 acquires the distribution of damage level of the sheet P on the basis of an output of the damage detection sensor 70 (ACT 201). The controller 60 specifies an area where the damage level exceeds a reference value (a damaged area) on the sheet P. A reference value is damage level for specifying that the sheet P is susceptible to damage by ejected ink and can be set as appropriate.

Subsequently, the controller 60 determines whether a printing area and the damaged area overlap each other (ACT 202). The printing area is an area where printing is scheduled to be performed. The controller 60 can determine, on the basis of a ratio of an area of the printing area overlapping the damaged area, whether the printing area and the damaged area overlap each other.

For example, if the ratio of the printing area overlapping the damaged area is higher than a predetermined value, the controller 60 can determine that the printing area and the damaged area overlap each other.

If the controller 60 determines that the printing area and the damaged area do not overlap each other (No in ACT 202), the controller 60 sets the printing area in a reference position (ACT 203). The reference position is a position of the printing area in forming an image on the sheet P for the first time and is a position determined on the basis of print data input to the image forming apparatus 1.

If the controller 60 determines that the printing area and the damaged area overlap each other (Yes in ACT 202), the controller 60 sets the printing area in a position shifted in a conveying direction of the sheet P with respect to the reference position (ACT 204). An amount of shift of the printing area can be set as appropriate.

The controller 60 performs print processing on the basis of the position of the printing area set in ACT 203 or ACT 204 (ACT 205). As a method of shifting the printing area in the conveying direction of the sheet P, for example, there is a method explained below.

For example; timing for causing the ink-jet heads 42P to 42K to eject ink can be varied when the printing area is formed in the reference position and when the printing area is formed in the position shifted from the reference position. Conveying speed of the sheet P by the belt 41 of the image forming unit 40 can be changed. Further, it is also possible to change both of the ejection timing for the ink and the conveying speed of the sheet P.

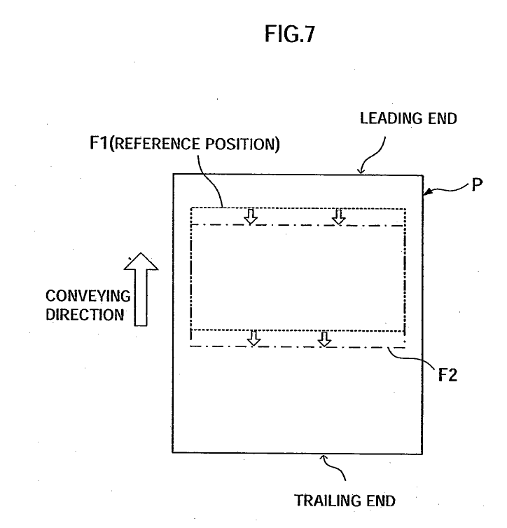

According to this embodiment, for example, as shown in FIG. 7, an image can be shifted in the conveying direction of the sheet P. In FIG. 7, a frame (an image) is formed on the sheet P. A frame F1 indicates an image formed in the reference position. A frame F2 indicates an image formed while being shifted from the reference position.

When a frame is formed on the sheet P, if frames are always formed in the same position, damage to the sheet P worsens in the position where the frames are formed. Therefore, as in this embodiment, a frame is formed while being shifted in the conveying direction of the sheet P. This makes it possible to distribute damage to the sheet P involved in the formation of a frame (an image).

### Third Embodiment

An image forming apparatus according to a third embodiment is explained below. The members explained in the first and second embodiments are denoted by the same reference numerals and signs and detailed explanation of the members is omitted.

In the second embodiment, a position of the printing area is shifted in the conveying direction of the sheet P. However, in the third embodiment, a position of the printing area is shifted in a direction orthogonal to the conveying direction of the sheet P, i.e., in the width direction of the sheet P. A configuration in this embodiment is specifically explained below.

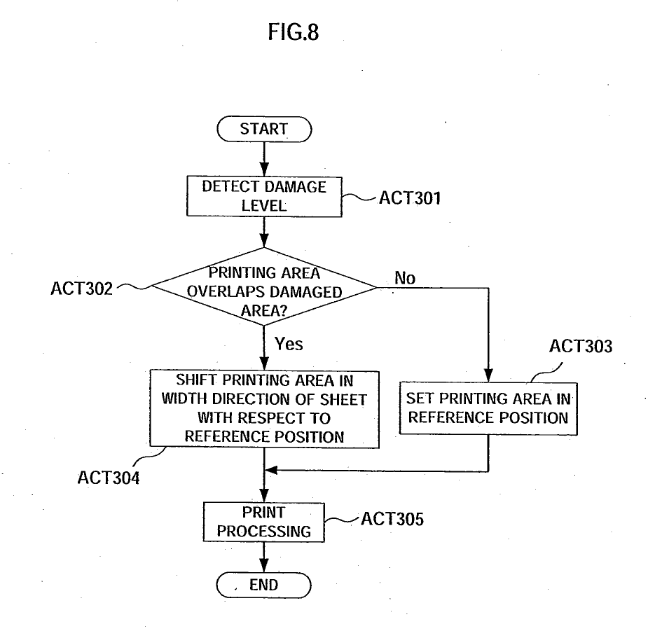

Image forming processing in this embodiment is explained below with reference to FIG. 8. Processing in ACT 301 to ACT 303 shown in FIG. 8 is the same as the processing in ACT 201 to ACT 203 shown in FIG. 6. In ACT 304, the controller 60 shifts the printing area in the width direction of the sheet P with respect to the reference position. In ACT 305, the controller 60 performs print processing.

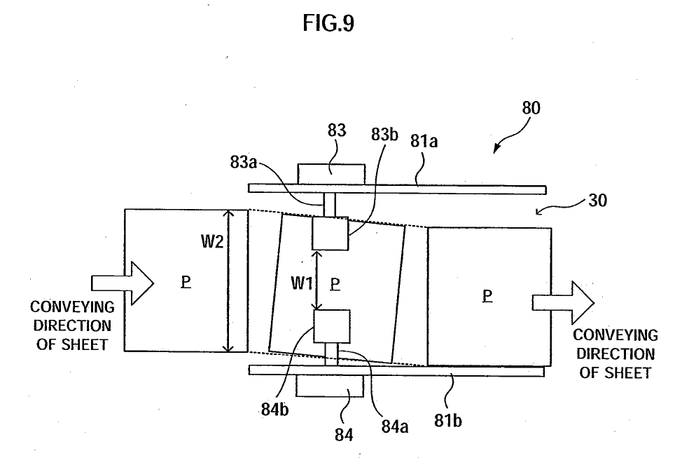

A mechanism for shifting the printing area in the width direction of the sheet P is explained with reference to FIG. 9. A shifting mechanism shown in FIG. 9 is arranged further on the upstream side of the sheet conveying path 30 than the image forming unit 40. The shifting mechanism can shift the sheet P in a direction orthogonal to the conveying direction of the sheet P (an up to down direction of FIG. 9).

A shifting mechanism 80 includes a pair of side plates 81a and 81b arranged on both sides of the sheet conveying path 30. Motors 83 and 84 are respectively attached to the side plates 81a and 81b. The motors 83 and 84 are arranged to be opposed to each other across the sheet conveying path 30. Driving of the motors 83 and 84 is controlled by the controller 60.

A roller 83b is fixed to an output shaft 83a of the motor 83. A roller 84b is fixed to an output shaft 84a of the motor 84. The output shafts 83a and 84a are located on the same axis. Space W1 between the pair of rollers 83b and 84b is set narrower than width W2 of the sheet P. The rollers 83b and 84b can come into contact with the sheet P led from the paper feeding cassette 20a to 20d.

The controller 60 can shift the sheet P in the width direction by varying rotating speeds of the rollers 83b and 84b. Specifically, in the processing in ACT 304 in FIG. 8, the controller 60 varies the rotating speeds of the rollers 83b and 84b. The speeds of the rollers 83b and 84b can be set as appropriate on the basis of a point to which the sheet P is shifted in the width direction. An amount of shifting the sheet P in the width direction can be changed by changing a difference between the rotating speeds of the rollers 83b and 84b.

In a state shown in FIG. 9, the rotating speed of the roller 83b is higher than the rotating speed of the roller 84b. The sheet P shifts to the side of the side plate 81b according to the rotation of the rollers 83b and 84b.

On the other hand, if the rollers 83b and 84b are rotated at the same speed, the sheet P is led to the image forming unit 40 without shifting in the width direction. Specifically, in the processing in ACT 303 in FIG. 8, the controller 60 rotates the rollers 83b and 84b at the same speed.

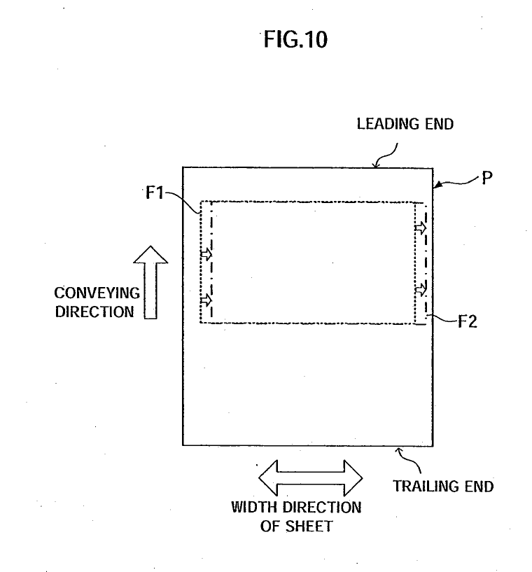

According to this embodiment, for example, as shown in FIG. 10, an image can be shifted in the width direction of the sheet P. In FIG. 10, a frame (an image) is formed on the sheet P. The frame F1 indicates an image formed in the reference position. The frame F2 indicates an image formed while being shifted from the reference position. In this embodiment, as in the second embodiment, it is possible to distribute damage to the sheet P involved in formation of an image.

In the second embodiment, the printing area is shifted only in the conveying direction of the sheet P. In the third embodiment, the printing area is shifted only in the width direction of the sheet P. However, the printing area can be shifted in the conveying direction and the width direction of the sheet P. In other words, the configuration in the second and third embodiments can be combined.

### Fourth Embodiment

An image forming apparatus according to a fourth embodiment is explained below. Members having functions same as those of the members explained in the above embodiments are denoted by the same reference numerals and signs and explanation of the members is omitted.

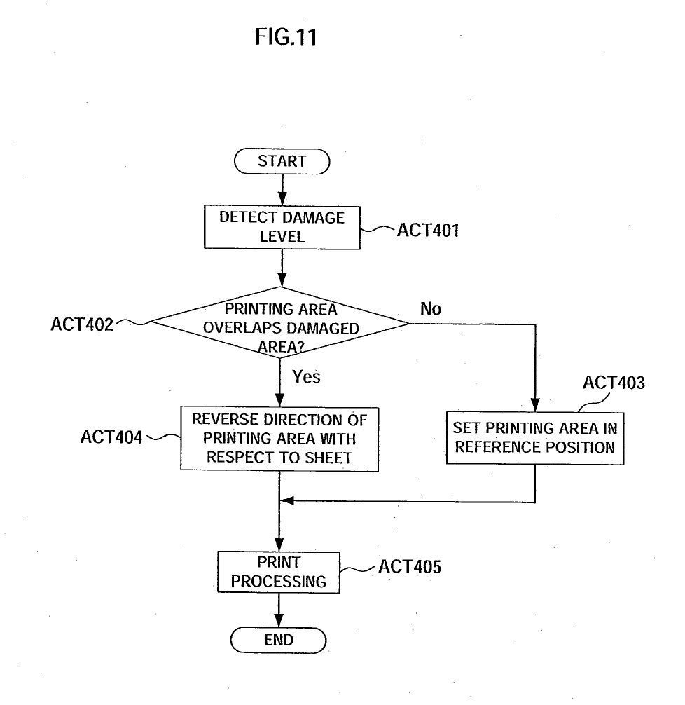

The operation of the image forming apparatus according to this embodiment is explained with reference to a flowchart shown in FIG. 11. Processing in ACT 401 and ACT 402 shown in FIG. 11 is the same as the processing in ACT 201 and ACT 202 explained with reference to FIG. 6. In ACT 402, when the sheet P is divided into two areas in the conveying direction of the sheet P, the controller 60 determines whether a printing area and a damaged area overlap each other in one area.

The determination concerning whether the printing area and the damaged area overlap each other is the same as the determination explained in the processing in ACT 202 shown in FIG. 6.

If the controller 60 determines in ACT 402 that the printing area and the damaged area do not overlap each other (No in ACT 402), the controller 60 sets the printing area in the reference position (ACT 403). If the controller 60 determines that the printing area and the damaged area overlap each other (Yes in ACT 402), the controller 60 reverses the direction of the printing area with respect to the sheet P. Specifically, the controller 60 corrects print data to reverse the direction of the printing area.

The controller 60 performs print processing on the basis of the printing area set in ACT 403 or AT 404 (ACT 405).

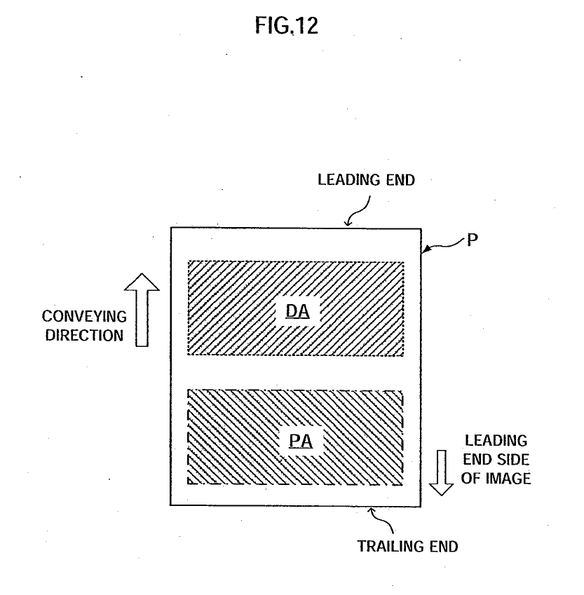

According to this embodiment, for example, as shown in FIG. 12, a printing area PA can be shifted in the conveying direction of the sheet P with respect to a damaged area DA. The printing area PA is reversed with respect to the sheet P. Therefore, as shown in FIG. 12, the leading end of the printing area PA is on the trailing end side of the sheet P.

According to this embodiment, it is possible to prevent the sheet P from being deteriorated by ejected ink.

The present invention can be carried out in various forms without departing from the spirit or the main characteristics thereof. Therefore, the embodiments explained above are merely simple illustrations in every aspect and should not be limitedly interpreted. The scope of the present invention is indicated by the appended claims and is by no means limited by the text of the specification. Further, all alterations and various improvements, substitutions, and modifications belonging to the scope of equivalents of the claims are within the scope of the present invention.

What is claimed is:

1. An image forming apparatus comprising:
an ink-jet head configured to eject ink to form an image on a sheet; and
a controller configured to control an amount of the ink ejected from the ink-jet head and reduce an ejection amount of the ink ejected to a damaged sheet to be smaller than an ejection amount of the ink ejected to an undamaged sheet.

2. The apparatus according to claim 1, further comprising a sensor configured to detect damage level of the sheet, wherein
the controller reduces the ejection amount of the ink ejected to the damaged sheet according to a rise in the damage level of the sheet detected by the sensor.

3. The apparatus according to claim 2, wherein
the sensor detects surface roughness of the sheet, and
the controller reduces the ejection amount of the ink according to an increase in fluctuation of the surface roughness.

4. The apparatus according to claim 2, wherein
the sensor detects thickness of the sheet, and
the controller reduces the ejection amount of the ink according to an increase in fluctuation of the thickness of the sheet.

5. The apparatus according to claim 2, further comprising a memory configured to store data indicating a correspondence relation between the damage level of the sheet and the ejection amount of the ink, wherein
the controller determines the ejection amount of the ink on the basis of the data stored in the memory and the damage level detected by the sensor.

6. The apparatus according to claim 1, wherein the ink is ink erasable by heating.

7. The apparatus according to claim 1, wherein
the apparatus includes a plurality of the ink-jet heads,
the ink-jet heads respectively eject inks of cyan, magenta, yellow, and black, and
the controller sets rates of decrease in ejection amounts substantially equal concerning the inks of cyan, magenta, yellow, and black.

8. An image forming method comprising:
reducing an ejection amount of ink ejected to a damaged sheet to be smaller than an ejection amount of the ink ejected to an undamaged sheet; and
ejecting the ink to form an image on the damaged sheet.

9. The method according to claim 8, further comprising:
detecting damage level of the sheet; and
reducing the ejection amount of the ink ejected to the damaged sheet according to a rise in the damage level.

10. The method according to claim 9, further comprising:
detecting surface roughness of the sheet; and
reducing the ejection amount of the ink according to an increase in fluctuation of the surface roughness.

11. The method according to claim 9, further comprising:
detecting thickness of the sheet, and
reducing the ejection amount of the ink according to an increase in fluctuation of the thickness of the sheet.

12. An image forming apparatus comprising:
an ink-jet head configured to eject ink to form an image on a sheet;
a sensor configured to detect damage level of a sheet; and
a controller configured to specify a damaged area in the sheet on the basis of an output of the sensor and vary, when the damaged area and a printing area overlap each other, timing for driving the ink-jet head to shift the printing area in a conveying direction with respect to the damaged area.

13. The apparatus according to claim 12, further comprising a shift mechanism configured to move the sheet in a direction orthogonal to the sheet conveying direction, wherein
the controller actuates, when the damaged area and the printing area overlap each other, the shift mechanism to shift the printing area in the direction orthogonal to the sheet conveying direction with respect to the damaged area.

14. An image forming apparatus comprising:
an ink-jet head configured to eject ink to form an image on a sheet;
a sensor configured to detect damage level of a sheet;
a shift mechanism configured to move the sheet in a direction orthogonal to a sheet conveying direction; and
a controller configured to specify a damaged area in the sheet on the basis of an output of the sensor and actuate, when the damaged area and a printing area overlap each other, the shift mechanism to shift the printing area in the direction orthogonal to the sheet conveying direction with respect to the damaged area.

15. The apparatus according to claim 14, wherein
the shift mechanism includes:
a pair of motors arranged in positions across a sheet conveying path and controlled by the controller; and
a roller attached to output shafts of the motors and configured to come into contact with the sheet moving on the sheet conveying path, and
the controller varies rotation speeds of the pair of motors to thereby shift the sheet in the direction orthogonal to the sheet conveying direction.

16. An image forming apparatus comprising:
an ink-jet head configured to eject ink to form an image on a sheet;
a sensor configured to detect damage level of a sheet; and
a controller configured to specify a damaged area in the sheet on the basis of an output of the sensor and actuate, when the damaged area and a printing area overlap each other, the ink-jet head on the basis of print data corrected to reverse a direction of the printing area with respect to the sheet.

17. The apparatus according to claim 12, wherein the ink is ink erasable by heating.

18. An image forming method comprising:
detecting damage level of a sheet and specifying a damaged area in the sheet; and
varying, when the damaged area and a printing area overlap each other, ejection timing of ink to shift the printing area in a sheet conveying direction with respect to the damaged area.

19. An image forming method comprising:
detecting damage level of a sheet and specifying a damaged area in the sheet; and
shifting, when the damaged area and a printing area overlap each other, the printing area in a direction orthogonal to a sheet conveying direction with respect to the damaged area.
